(19) United States
(12) Patent Application Publication
(10) Pub. No.: US 2011/0239817 A1
(43) Pub. Date: Oct. 6, 2011

(54) DETACHABLE MECHANISM OF BICYCLE PEDAL AND LOCKING SHOE

(76) Inventor: Ming-Hui CHANG, Taipei (TW)

(21) Appl. No.: 12/749,530

(22) Filed: Mar. 30, 2010

(51) Int. Cl. B62M 3/08; A43B 5/14

(52) U.S. Cl. 74/594.6; 36/131

(57) ABSTRACT

The present invention provides a detachable mechanism of bicycle pedal and locking shoe, wherein a magnetic absorber is set on the bicycle pedal in collaboration with an adsorbed unit on the bottom of the locking shoe, enabling easy coupling or disengagement; meanwhile, the bottom of the locking shoe is provided with a [symbol] -shaped groove mating with the frame of the bicycle pedal, so that the locking shoe can be coupled with the bicycle pedal more stably and robustly; moreover, an oblique surface is formed on the same lateral wall of two channels of the groove, such that the locking shoe can be more easily mated with the bicycle pedal in an oblique angle; furthermore, marks are printed on the inner edge of the locking shoe corresponding to two channels of [symbol] -shaped groove, enabling rapid coupling by the beginners.

### BACKGROUND OF INVENTION

1. Field of the Invention

The present invention relates generally to a mechanism of bicycle pedal and its locking shoe, and more particularly to an improved one which allows for rapid and easy assembly and detachment of the mechanism, and also enables the locking shoe to walk on the road for the sake of the riders.

2. Description of Related Art

Bicycles are commonly used by the users as an alternative short-distance vehicle since they meet the demands of environmental protection; in particular, bicycle exercises are recently widespread given the fact that the sport of cycling can not only realize energy conservation but also improve physical fitness.

Bicycle racing is still one of popular sports today, which attracts the attention of many people to make physical exercises for strengthening their physical strength, endurance and spirit.

However, when riding a bicycle, users need to step on the pedals to push or pull them so as to generate certain moving speed. The most efficient method for common riding or competition is to transfer the force completely from the feet to the pedals. In such case, the mating of the shoes and the bicycle pedals is of great importance. For this reason, some athletic or special bicycles are equipped with so-called pedal clip and toe clip that are mated with the pedals. When the users step on the pedals, the temporary positioning of the pedal clip or toe clip enables back-and-forth treading, thus realizing optimum treading efficiency.

However, there are a variety of pedal clips and toe clips as well as different operating modes, requiring a period of time to adapt them for the beginners. As for the common users without skillful experience, they often face the problems such as unsmooth pulling on or taking off the shoes, leading to falling down due to loss of support and balance.

In addition, either of the pedal clip or the toe clip requires the improvement of the shoes, namely, a caliper is protruded from the bottom of the shoes; prior to use, the caliper is employed to lock the pedal clip or toe clip, so as to realize optimum treading efficient during movement; yet, such shoes of caliper structure cannot walk on the road, especially on the indoor floor, otherwise leading possibly to damage; on the other hand, in the event of emergent situations when pulling on such shoes, the users may find it very difficult to take off the shoes or disengage them from the pedals, bringing about great hazard. Moreover, this makes it impossible for temporary stop during the movement due to lack of support.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### CONTENT OF INVENTION

The primary objective of the present invention is to provide a detachable mechanism of bicycle pedal and locking shoe, enabling the riders to use it more conveniently and safely while meeting various actual demands.

To achieve the above objective, the detachable mechanism comprises an improved structure of the bicycle pedal and locking shoe; of which the improved bicycle pedal is characterized by that, a magnetic absorber is embedded into the pedal; the locking shoe is characterized by that, an adsorbed unit at least flushed with or inserted into the bottom is arranged for the magnetic absorber, and a [symbol] -shaped groove mating with the frame of the bicycle pedal is set; with this design, either the beginners or the skilled persons can pull on or take off the shoes quickly, especially in the event of emergency, thus preventing the hazards with its outstanding safety and convenience.

Moreover, marks are set separately on the inner edge of said locking shoe corresponding to two channels of the groove, enabling easy alignment or coupling by the beginners; an oblique surface is formed on the same lateral wall of two channels of the groove, so that one wall (front wall) of the channel has an oblique surface, and the other wall (rear wall) has a vertical surface, thus permitting rapid guiding and efficient blocking effects.

The features and the advantages of the present invention will be more readily understood by the patent examiners and skilled persons upon a thoughtful deliberation of the following detailed description of a preferred embodiment of the present invention with reference to the accompanying drawings.

### SUMMARY OF THE INVENTION

Referring to FIG. 1, the “detachable mechanism of bicycle pedal and locking shoe” of the present invention comprises: a bicycle pedal 1 and a locking shoe 2.

The bicycle pedal 1, provided with an axle bracket 10 pivoted with one end of the pedal crank, and fitted with a [symbol] -shaped frame 11; a warning light 12 is set properly on the frame 11;

The locking shoe 2, available with a main body and shape similar to common shoe, allowing to step on or couple with the bicycle pedal 1.

Referring to FIGS. 2, 3, the present invention is characterized by that:

a detachable or removable magnetic absorber 3 is set properly at the hollowed position between the axle bracket 10 and frame 11 of the bicycle pedal 1, and fastened by a locker 302; moreover, an adsorbed unit is flushed with or inserted into the bottom of locking shoe 2 for the magnetic absorber, and a [symbol] -shaped groove 5 mating with the frame 11 of the bicycle pedal 1 is set.

When the locking shoe 2 treads on the bicycle pedal 1, the groove 5 on the bottom and the frame 11 are jogged, and the magnetic absorber 3 can adsorb the corresponding adsorbed unit 4, realizing stable and robust coupling effect. In the case of treading by the riders, this structure allows for smooth “pushing” and “pulling” of the feet for rapid movement and most efficient treading efficiency; meanwhile, in the event of emergency, users may disengage their feet quickly from the bicycle pedal 1, or just lift up to obtain an equilibrium effect, or jump off the bicycle to ensure the personal safety.

Said magnetic absorber 3 also comprises: a block 30 with hollow round hole 301, a magnetic body 31, an elastic body 32 and a locking member 33; the hollow round hole 301 of block 30 is designed obliquely and aligned with the adsorbed unit 4 for accommodating it; the magnetic body 31, elastic body 32 and locking member 33 are arranged therein in sequence; the magnetic body 31 of strong magnetic force can adsorb the adsorbed unit 4; the elastic body 32 is used to support the magnetic body 31, preventing the degradation of magnetic force due to long-lasting treading of the locking shoe 2; the locking member 33 is used for locking securely the other end of the elastic body 32, so as to maintain the elasticity of the elastic body 32.

Moreover, marks 20, e.g.: marking line or arrow, are set separately on the inner edge of said locking shoe 2 corresponding to two channels of the groove 5, enabling easy alignment or coupling of the locking shoe 2 and bicycle pedal 1 by the beginners. This also helps to observe the position and then guide the action while shortening the time of learning and adaptation.

Furthermore, to ensure quicker coupling of the locking shoe 2 and the bicycle pedal 1, an oblique surface 50 is designed on the same lateral wall of two channels of the [symbol] -shaped groove 5, so that one wall (front wall) of the channel has an oblique surface, and the other wall (rear wall) has a vertical surface, thus permitting rapid guiding and efficient blocking effects.

Thus, the “detachable mechanism of bicycle pedal and locking shoe” of the present invention is specifically designed with magnetic force, so that the locking shoe can be rapidly coupled with or disengaged from the bicycle pedal for the convenient operation by the beginners or skilled riders. Meanwhile, the marks for guiding purpose are also set for locking onto the wall of anti-skidding channel, thereby improving significantly the functionality and practicability of the product; in particular, the locking shoe without a protruding bottom can be separated where necessary, to support the bicycle with better safety and convenience, or can walk freely on the floor or road surface without damage to itself or the road surface.

To sum up, the present invention has advantages over prior art, and also exceeds the range of typical application without equivalent or similar invention or publication, so the following claims are made since it conforms to the demand of patent application.

### BRIEF DESCRIPTION OF THE DRAWINGS

FIG. 1 shows an exploded view of the bicycle pedal and locking shoe of the present invention.

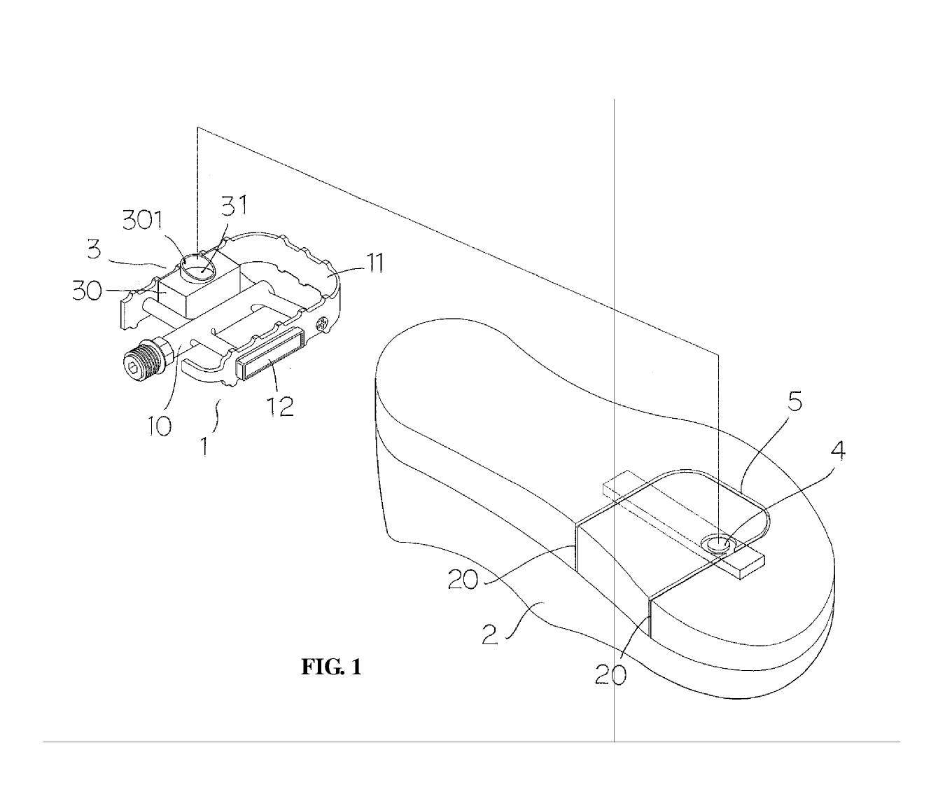

FIG. 2 shows an exploded view of the bicycle pedal of the present invention.

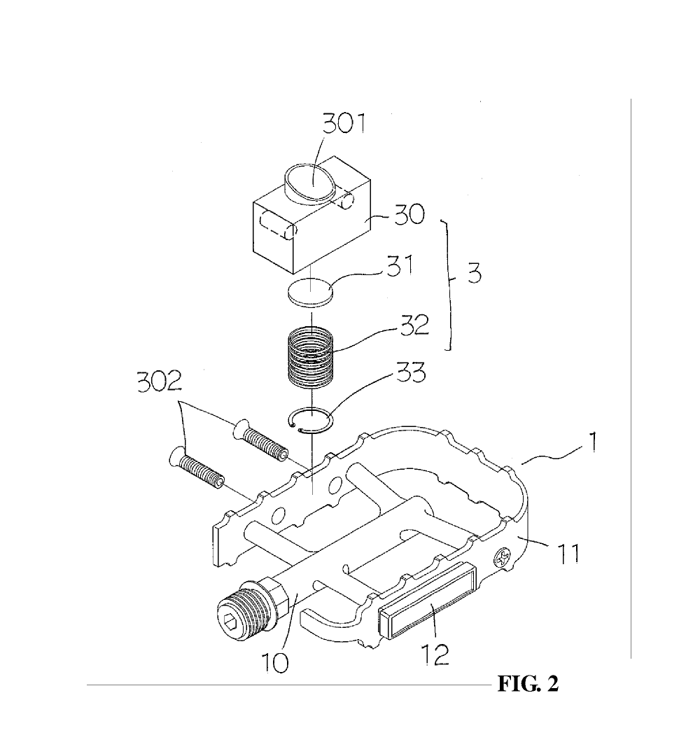

FIG. 3 shows an assembled view 1 of the bicycle pedal and locking shoe of the present invention.

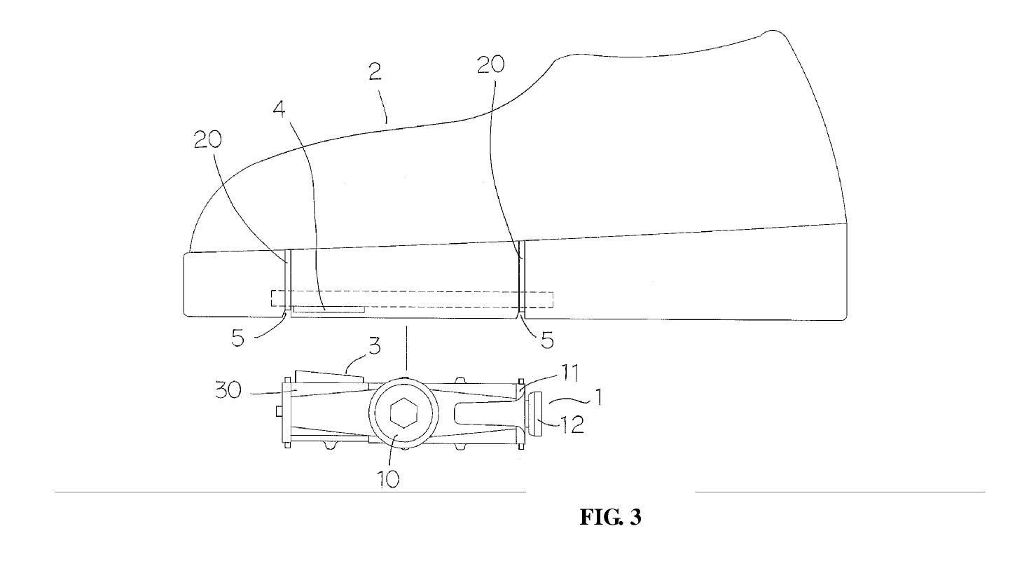

FIG. 4 shows an assembled view 2 of the bicycle pedal and locking shoe of the present invention.

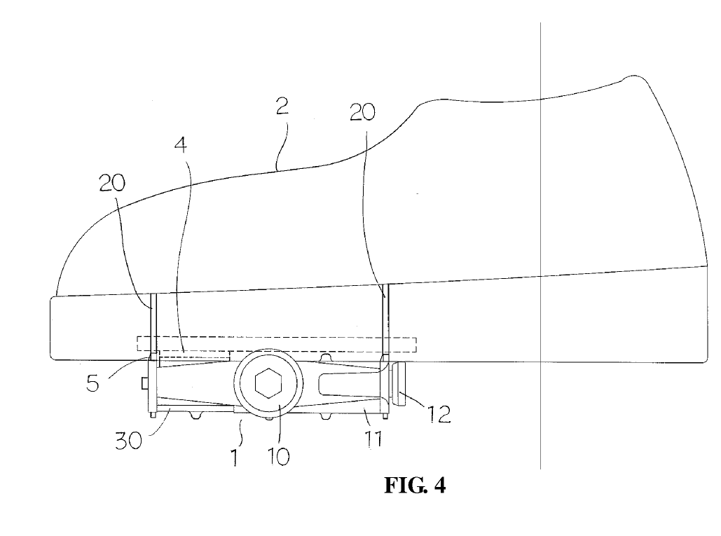

1. A detachable mechanism of bicycle pedal and locking shoe, which comprising:
a bicycle pedal, which is composed of an axle bracket and a frame, and fitted with a magnetic absorber; and
a locking shoe, with its bottom provided with an adsorbed unit corresponding to the magnetic absorber, as well as a [symbol] -shaped groove mating with the frame of bicycle pedal.

2. The detachable mechanism of bicycle pedal and locking shoe as claimed in claim 1, wherein the magnetic absorber also comprises a block with hollow round hole, a magnetic body, an elastic body and a locking member.

3. The detachable mechanism of bicycle pedal and locking shoe as claimed in claim 2, wherein one end of the hollow round hole is of oblique shape.

4. The detachable mechanism of bicycle pedal and locking shoe as claimed in claim 2, wherein the block is set on the bicycle pedal and fastened by the locker.

5. The detachable mechanism of bicycle pedal and locking shoe as claimed in claim 1, wherein the adsorbed unit at the bottom of the locking shoe is flushed with or inserted into the bottom.

6. The detachable mechanism of bicycle pedal and locking shoe as claimed in claim 1, wherein marks are set separately on the inner edge of said locking shoe corresponding to two channels of the groove.

7. The detachable mechanism of bicycle pedal and locking shoe as claimed in claim 1, wherein an oblique surface is formed on the same lateral wall of two channels of the groove.
